(19) United States
(12) Patent Application Publication
(10) Pub. No.: US 2010/0082909 A1
(43) Pub. Date: Apr. 1, 2010

(54) MEMORY SYSTEM AND CONTROL METHOD

(75) Inventor: Hiroshi Asakai, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/557,880

(22) Filed: Sep. 11, 2009

(30) Foreign Application Priority Data
Sep. 26, 2008 (JP) 2008-248378

(51) Int. Cl. G06F 12/00

(52) U.S. Cl. 711/148; 711/E12.001

(57) ABSTRACT

A control method for a memory system includes a plurality of processing apparatuses each having a comparison data holding area and a replacement data holding area, and a plurality of storage units each having a readout data holding area rewritably holding readout data and a memory unit shared by the plurality of processing apparatuses. The control method includes issuing an exclusive control instruction to exclusively access to one of the memory units from one of the processing apparatuses, sending comparison data to one of the plurality of storage units from the comparison data holding area of the one of the processing apparatuses when the exclusive control instruction is executed, and comparing the comparison data sent from the one of the processing apparatuses with the readout data in the storage unit.

### CROSS-REFERENCE TO RELATED APPLICATION

This application is based upon and claims priority to prior Japanese Patent Application No. 2008-248378 filed on Sep. 26, 2008 in the Japan Patent Office, the entire contents of which are incorporated herein by reference.

### FIELD

The embodiments discussed herein are related to a memory system and a control method.

### BACKGROUND

FIG. 4 schematically illustrates a configuration of a conventional memory system.

The conventional memory system 100 is for example a computer system configured as a multi-cluster system including a plurality of clusters that are information processing apparatuses. As illustrated in FIG. 4, the memory system 100 includes a plurality of (two in the example illustrated in FIG. 4) clusters (information processing apparatuses) 201a, 201b and a plurality of (two in the example illustrated in FIG. 4) SSUs (System Storage Units) 301a, 301b.

The SSUs 301a and 301b are storage units from which data is read and to which data is written. As illustrated in FIG. 4, the SSU 301a includes a memory 302a and interface units 303a-1 and 303a-2 and the SSU 301b includes a memory 302b and interface units 303b-1 and 303b-2.

The SSUs 301a and 301b store data sent from the clusters 201a and 201b. In the memory system 100 illustrated in FIG. 4, two clusters 201a and 201b share the two SSUs 301a and 301b.

Each of the memories 302a and 302b stores data readably and writably and may be implemented by a device such as an HDD (Hard Disk Drive) or an SSD (Semiconductor Storage Device).

The interface units 303a-1, 303a-2, 303b-1, and 303b-2 control writing and reading data to and from the memories 302a and 302b. The interface units 303a-1, 303a-2, 303b-1, and 303b-2 perform processing such as data write to and read from the memories 302a and 302b according to instructions (requests) from the clusters 201a and 201b and return results (result reports) to the clusters 201a and 201b that sent the instructions.

The memory 302a is shared through the interface units 303a-1 and 303a-2 and data can be written and read in the memory 302a through either of the interface units 303a-1 and 303a-2. Likewise, the memory 302b is shared through the interface units 303b-1 and 303b-2 and data can be written and read in the memory 302b through either of the interface units 303b-1 and 303b-2.

In the conventional memory system 100, identical data is written in the SSUs 301a and 301b. Thus, data duplication or redundancy can be achieved.

In particular, identical data is stored in at least a part of a duplication data area in the memory 302a of the SSU 301a and a part of a duplication data area in the memory 302b of the SSU 301b. Therefore, if any of the SSUs 301a and 301b fails, the clusters 201a and 201b can access the identical data in the other of the SSUs 301b and 301a.

The data areas store comparison data or data patterns used in access control of exclusive control instructions by the clusters 201a and 201b, which will be described later. In the example illustrated in FIG. 4, readout patterns DA0 and DA1 are stored in the memories 302a and 302b, respectively, in a rewritable manner.

The clusters 201a and 201b are information processing apparatuses communicably connected to the SSUs 301a and 301b through communication cables such as FC (Fibre Channel) interface cables or parallel interface cables. As illustrated in FIG. 4, the cluster 201a includes a CPU (Central Processing Unit) 202a and a memory unit 203a as a main memory and the cluster 201b includes a CPU 202b and a memory unit 203b.

The CPUs 202a and 202b are processors performing various computational operations and control and implement various functions by executing programs stored in the memory unit 203a and memories 302a, 302b, as well as storage devices, not shown.

The clusters 201a and 201b store data in the SSUs 301a and 301b while performing various kinds of processing.

The cluster 201a is connected to the interface unit 303a-1 of the SSU 301a and the interface unit 303b-1 of the SSU 301b. The cluster 201b is connected to the interface unit 303a-2 of the SSU 301a and the interface unit 303b-2 of the SSU 301b.

In the following description, reference symbol 201a or 201b is used when one of a plurality of clusters needs to be identified whereas 201 is used for referring to any of the clusters.

In the conventional memory system 100, the SSU 301a of the two SSUs 301a and 301b is treated as the master and SSU 301b as a slave.

When processing relating to the readout patterns DA0 in the SSU 301a in the conventional system 100 and the readout patterns DA1 in the SSU 301b in the conventional system 100, one of the cluster 201a and the cluster 201b is exclusively granted access.

The memory units 203a and 203b store various kinds of data and programs. A permission pattern AP0 and a next permission pattern NP0 are stored in the memory unit 203a and a permission pattern AP1, and a next permission pattern NP1 are stored in the memory unit 203b.

The permission patterns AP0 and AP1 and the next permission patterns NP0 and NP1 are data used by the clusters 201a and 201b for executing exclusive control instructions on the SSUs 301a and 301b. Each of the permission patterns AP0, AP1 and the next permission patterns NP0, NP1 has the same number of bits (data size) as the aforementioned readout patterns DA0, DA1.

The clusters 201a and 201b control access by using CAS (Compare-And-Swap) when an exclusive control instruction is executed to the SSUs 301a and 301b.

The permission patterns AP0 and AP1 are used as comparison values with which readout pattern DA0 stored in the memory 302a is compared in the access control using CAS. The next permission patterns NP0 and NP1 are used as replacement values with which readout pattern DA0 stored in the memory 302a mentioned above is replaced. The next permission patterns NP0 and NP1 have been generated so as to match the permission patterns AP0 and AP1.

The permission patterns AP0 and AP1 differ from one another, and the next permission patterns NP0 and NP1 differ from one another.

Specifically, for example the permission patterns AP0 and AP1 are information indicating the order in which the clusters access the memories 302a, 302b as shared resources of the SSUs 301a, 301b. The cluster 201 that has the smaller value of the permission pattern AP0, AP1 has the first access to the memories 302a, 302b.

The next permission patterns NP0 and NP1 are information (greater values) indicating the order next to the permission patterns AP0 and AP1.

The permission patterns AP0, AP1 and the next permission patterns NP0, NP1 are updated (incremented) each time the shared resources are accessed by a cluster 201.

In the conventional memory system 100, one of the two clusters 201 is granted access. After a cluster 201 gains access, the cluster 201 that has access (for example cluster 201a) overwrites each readout pattern DA0, DA1 of the SSUs 301a, 301b with the same next permission pattern NP0, thereby replacing the patterns.

Referring to FIG. 5, a process flow will be described that is performed when a cluster 201 in the conventional memory system 100 successfully has gained access to the SSUs 301a, 301b. In the example in FIG. 5, the cluster 201a has gained access.

In the following description, gaining by a cluster 201 the first access to the memories 302a, 302b as shared resources of the SSUs 301a, 301b after the cluster 201 currently accessing the memories 302a, 302b is sometimes referred to as gaining access to a permission pattern.

First, the cluster 201a issues a request to read the permission pattern AP0 to the memory unit 203a. The memory unit 203a returns the permission pattern AP0 (refer to a1 in FIG. 5) and the cluster 201a stores the permission pattern AP0 in a register (not shown).

The cluster 201a also issues a locked-read of the readout pattern DA0 to the master SSU 301a (see a2 in FIG. 5).

In the conventional memory system 100, when a locked-read of the readout pattern DA0 is granted to the cluster 201a, the SSU 301a does not permit cluster 201b to perform a locked-read access to the readout pattern DA0 until the cluster 201a issues an unlock request.

The readout pattern DA0 is read from the memory 302a in the SSU 301a (see a3 in FIG. 5) and is sent to cluster 201a as the result of the read (see a4 in FIG. 5). The cluster 201a stores the readout pattern DA0 sent from the SSU 301a in a register (not shown).

The cluster 201a compares the readout pattern DA0 with the permission pattern AP0 (see a5 in FIG. 5). If the readout pattern DA0 matches the permission pattern AP0, the cluster 201a issues a request to read the next permission pattern NP0 to the memory unit 203a. When the next permission pattern NP0 is returned from the memory unit 203a (see a6 in FIG. 5), the cluster 201a stores the next permission pattern NP0 in the register (not shown).

The cluster 201a issues a request for a duplication write of the readout patterns DA0 and DA1 to the SSUs 301a and 301b, respectively (see a7 in FIG. 5; duplication write request) and sends the next permission pattern NP0 to the SSUs 301a and 301b.

In each of the SSUs 301a and 301b, preparation for replacing the readout pattern DA0 is performed (see a8 in FIG. 5) and then the readout pattern DA0 is replaced with the next permission pattern NP0, thereby accomplishing the duplication write (see a9 in FIG. 5). The SSUs 301a and 301b send a report to the cluster 201a indicating that the duplication write has been completed (a duplication write completion report) (see a10 in FIG. 5).

When the duplication write completion reports of the readout patterns DA0 and DA1 are returned from the SSUs 301a and 301b, the cluster 201a sends an unlock request to the SSU 301a (see a11 in FIG. 5).

The SSU 301a executes unlocking (see a12 in FIG. 5) and then sends a report that the unlocking has been completed to the cluster 201a (see a13 in FIG. 5).

Since the cluster 201a has gained access to a permission pattern, cluster 201a becomes the only cluster 201 that can perform an operation on that permission pattern. The next permission pattern NP0 has been generated so as to match the permission pattern AP0.

In the conventional memory system 100, if the cluster 201b attempts a locked-read of the readout pattern DA0 while the cluster 201a is performing a locked-read of the readout pattern DA0, the SSU 301a permits cluster 201b to perform the locked-read of the readout pattern DA0 after the SSU 301a has received the unlock request from the cluster 201a. Then, the next permission pattern NP0, which has been written by cluster 201a, is read as the readout pattern DA0.

Here, since the readout pattern DA0 obtained (which is identical to the next permission pattern NP0) does not match its own permission pattern AP1 stored in the memory unit 203b, cluster 201b issues an unlock request to the SSU 301a and notifies the SSU 301a of end of the locking operation.

The cluster 201b modifies the permission pattern AP1 to be identical to the next permission pattern NP0, generates next permission pattern NP1 so as to match the permission pattern AP1, and attempts a locked-read of the readout pattern DA0.

When the cluster 201b performed a locked-read of the readout pattern DA0 as described above and if the cluster 201a did not modify the readout pattern DA0 in the period between the time cluster 201b ended locking operation due to the mismatch between DA0 (NP0) and AP1 and the time the cluster 201b attempted the lock-read of the readout pattern DA0 again, the permission pattern AP1 matches the readout pattern DA0. Therefore, cluster 201b performs a duplication write to the readout patterns DA0 and DA1 with the next permission pattern AP1 and, after completion of the duplication write, and after completion of the write of the readout patterns, issues an unlock request to the SSU 301a and notifies the SSU 301a of end of the locking operation.

Because the cluster 201b has gained access, cluster 201b becomes the only cluster 201 that can perform processing on the permission pattern.

Referring to FIG. 6, a process flow will be described that is performed when cluster 201a in the conventional memory system 100 has failed to gain access to the SSUs 301a and 301b.

First, the cluster 201a issues a request to read the permission pattern AP0 to the memory unit 203a. The memory unit 203a returns the permission pattern AP0 (see b1 in FIG. 6) and the cluster 201a stores the permission pattern AP0 in a register (not shown).

The cluster 201a attempts a locked-read of the readout pattern DA0 in the master SSU 301a (see b2 in FIG. 6).

In the conventional memory system 100, when a locked-read of readout pattern DA0 is granted to the cluster 201a, the SSU 301a does not permit cluster 201b to perform a locked-read of the readout pattern DA0 until cluster 201a issues an unlock request.

In the SSU 301a, the readout pattern DA0 is read from the memory 302a (see b3 in FIG. 6) and is sent to the cluster 201a as a read result report (see b4 in FIG. 6). The cluster 201a stores the readout pattern DA0 sent from the SSU 301a in a register (not shown).

The cluster 201a compares the readout pattern DA0 with the permission pattern AP0 (see b5 in FIG. 6). If the readout pattern DA0 does not match the permission pattern AP0, the cluster 201a sends an unlock request to the SSU 301a (see b6 in FIG. 6).

The SSU 301a performs unlocking (see b7 in FIG. 6) and then sends a report to cluster 201a indicating that the unlocking has been completed (see b8 in FIG. 6).

### SUMMARY

A control method for a memory system includes a plurality of processing apparatuses each having a comparison data holding area and a replacement data holding area, and a plurality of storage units each having a readout data holding area rewritably holding readout data and a memory unit shared by the plurality of processing apparatuses. The control method includes issuing an exclusive control instruction to exclusively access to one of the memory units from one of the processing apparatuses, sending comparison data to one of the plurality of storage units from the comparison data holding area of the one of the processing apparatuses when the exclusive control instruction is executed and comparing the comparison data sent from the one of the processing apparatuses with the readout data in the storage unit.

A memory system including a plurality of processing apparatuses each having a processor, and a plurality of storage units each having a memory unit communicably connected to each of the plurality of processing apparatuses and being shared by the plurality of processing apparatuses, each of the plurality of processing apparatuses being capable of executing an exclusive control instruction to exclusively access the memory unit. Each of the processing apparatuses includes a comparison data holding area holding comparison data, a replacement data holding area holding replacement data, and a comparison data sending unit sending the comparison data to one of the plurality of storage units when the exclusive control instruction to the memory unit is executed. The storage unit includes a readout data holding area rewritably holding readout data and a comparing unit comparing the comparison data sent from the processing apparatus with the readout data.

### BRIEF DESCRIPTION OF THE DRAWINGS

FIG. 1 is a diagram schematically illustrating a configuration of a memory system in one embodiment;

FIG. 2 is a diagram illustrating a flow of process performed when a cluster in the memory system of the embodiment has gained access to SSUs;

FIG. 3 illustrates a flow of process performed when a cluster in the memory system of the embodiment has failed to gain access to SSUs;

FIG. 4 schematically illustrates a configuration of a conventional memory system;

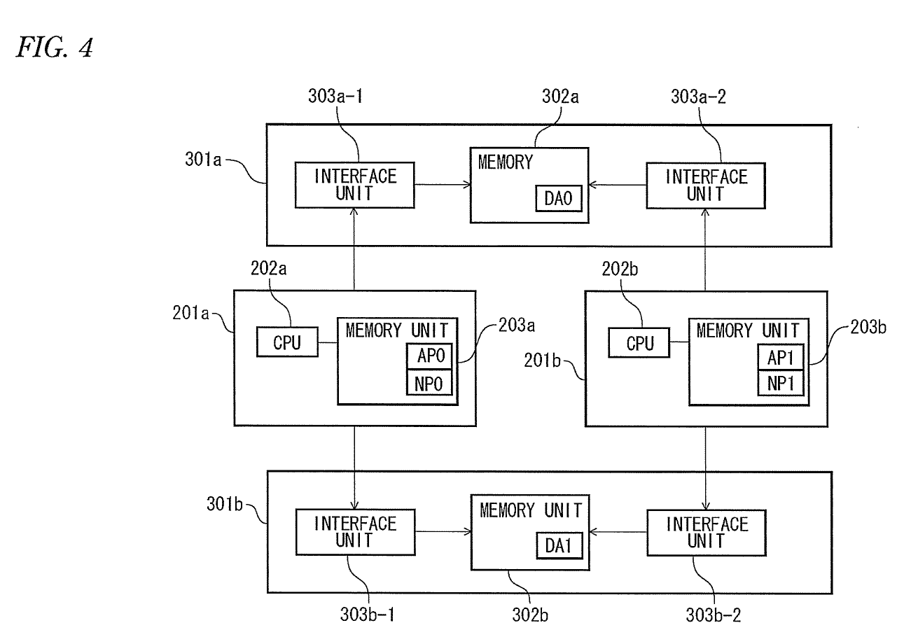

FIG. 5 illustrates a method for controlling an exclusive write to SSUs in the conventional memory system; and

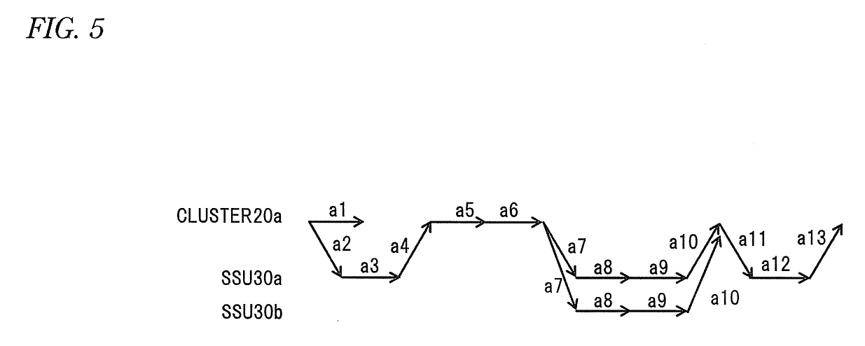

FIG. 6 illustrates a method for controlling an exclusive write to SSUs in the conventional memory system.

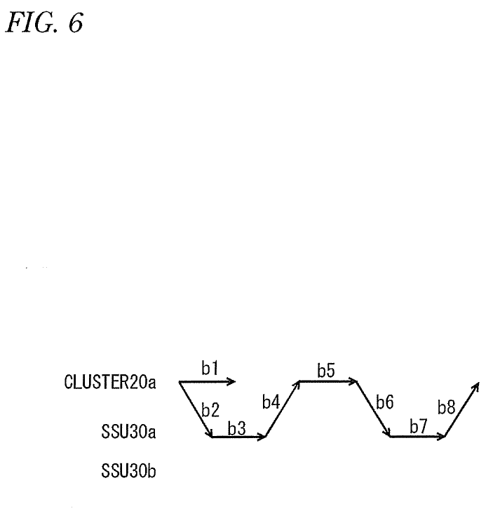

### DETAILED DESCRIPTION OF THE EMBODIMENTS

Embodiments of the present memory system and control method will be described with reference to the drawings.

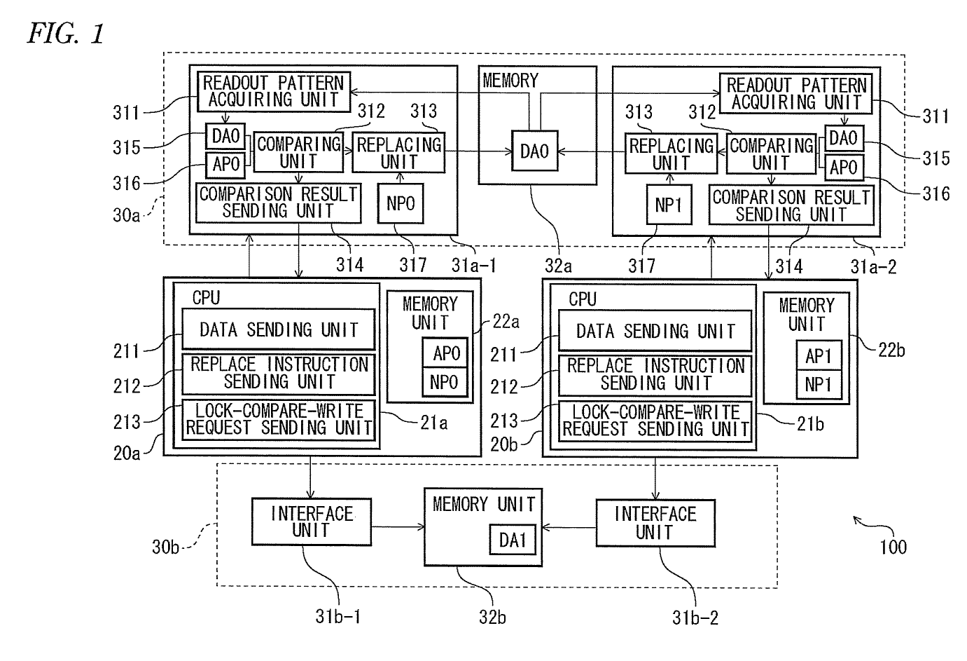

FIG. 1 schematically illustrates a configuration of a memory system that is one embodiment.

The memory system 100 is a computer system configured as, for example, a multi-cluster system including multiple clusters. The memory system 100 includes two clusters, which are information processing apparatuses 20a and 20b, and two SSUs, which are storage units 30a and 30b, as illustrated in FIG. 1.

The clusters 20a and 20b are information processing apparatuses connected to the SSUs 30a and 30b through interconnections such as FC (Fibre Channel) cables or parallel cables in such a manner that they can communicate with each other, and store data in the SSUs 30a and 30b while performing various kinds of processing.

As illustrated in FIG. 1, the cluster 20a includes a CPU 21a and a memory unit 22a as a main memory and the cluster 20b includes a CPU 21b and a memory unit 22b as a main memory.

The cluster 20a is connected to an interface unit 31a-1 of the SSU 30a and an interface unit 31b-1 of the SSU 30b, which will be described later, and the cluster 20b is connected to an interface unit 31a-2 of the SSU 30a and an interface unit 31b-2 of the SSU 30b.

In the following description, reference symbol 20a or 20b is used when one of the multiple clusters needs to be identified whereas 20 is used for referring to any of the clusters.

Likewise, reference symbol 30a or 30b is used when one of the multiple SSUs needs to be identified whereas 30 is used for referring to any of the SSUs.

The SSU 30a of the two SSUs 30a and 30b is treated as the master and the SSU 30b is treated as a slave in the memory system 100. When an exclusive control instruction, which will be described later, is executed, various kinds of processing such as access granting related to exclusive control are performed between the cluster 20 and the master SSU 30a of the SSUs 30.

The cluster 20 performs processing relating to access with the master SSU 30a. It can be determined which of the multiple SSUs 30 is a master or a slave by making settings previously in the SSUs 30 specifying that they are in a master node or a slave mode.

For example, a physical switch, such as a jumper switch or DIP (Dual In-line Package) switch, may be used to make settings that enable master/slave recognition. Alternatively, a software flag that enables master/slave recognition may be set in a predetermined area in memories 32a, 32b. Variations are possible without departing from the spirit of the present embodiments.

Based on the settings, each cluster 20 and SSU 30 determines whether the SSU 30 is a master or slave.

The memory units 22a and 22b store various kinds of data and programs in a readable manner.

The memory unit 22a also stores a permission pattern (comparison data) AP0 and a next permission pattern (replacement data) NP0 in a rewritable manner. The memory unit 22b stores a permission pattern (comparison data) AP1 and a next permission pattern (replacement data) NP1 in a rewritable manner.

The permission patterns AP0 and AP1 and the next permission patterns NP0 and NP1 are used by the clusters 20a and 20b to execute exclusive control instructions such as CAS (Compare-and-Swap) instructions.

Here, the permission patterns AP0, AP1 and the next permission patterns NP0, NP1 are different patterns having the same number of bits (data size).

In particular, the permission patterns AP0 and AP1 are information indicating the order of access to the memories 32a and 32b as shared resources of the SSUs 30a and 30b. The cluster 20 that has the smaller one of the values of the permission patterns AP0 and AP1 has the first access to the memories 32a and 32b.

The next permission patterns NP0 and NP1 are information indicating the order next to the permission patterns AP0 and AP1.

Each of the permission patterns AP0, AP1 and the next permission patterns NP0, NP1 are updated (incremented) each time the shared resource is accessed by the cluster 20. For example, the value of the next permission pattern NP0 is set in the permission pattern AP0 (AP0=NP0) and the value of the next permission pattern NP0 is incremented (NP0=NP0+1).

Any of the commonly used methods in CAS may be used for setting values for the permission patterns AP0, AP1, the next permission patterns NP0, NP1, and the readout pattern DA0 and therefore detailed description of the method will be omitted.

For an exclusive control instruction to the SSUs 30a, 30b, the cluster 20 having the permission pattern AP0 that matches the readout pattern DA0 is assumed to have access to the SSUs 30a, 30b and the readout pattern DA0 is replaced with the next permission pattern NP0.

In the description of the present embodiment, gaining by a cluster 20 the first access to the memories 32a, 32b as shared resources of the SSUs 30a, 30b is sometimes referred to as gaining access to the permission pattern.

When an exclusive control instruction is executed on the SSUs 30a, 30b in the memory system 100, access is exclusively granted to only one of the clusters 20 in order to avoid contention for the resources (SSUs 30a, 30b) among the clusters 20.

In access control relating to an exclusive control instruction, the permission pattern AP0, AP1 is used as comparison data compared with a comparison pattern DA0 stored in the memory 30a, which will be described later. The next permission pattern NP0, NP1 is used as replacement data with which the comparison pattern DA0 stored in the memory 32a is replaced.

That is, in the memory system 100, the memory units 22a and 22b function as comparison data holding areas holding the permission patterns (comparison data) AP0 and AP1 and also function as replacement data holding areas holding the replacement data NP0 and NP1 which are the next permission patterns.

The next permission patterns NP0 and NP1 are generated so as to match the permission patterns AP0 and AP1.

When one of the two clusters 20 gains access, the cluster 20 that has access writes the same data over the comparison patterns DA0 and DA1 in the SSUs 30a and 30b.

The CPUs 21a and 21b are processors which perform various computational operations and control and, execute, programs stored in the memory unit 22a and the memories 30a and 30b, for example, as well as storage devices, not shown, to implement various functions.

For example, the CPUs 21a and 21b in the memory system 100 execute such programs to function as a data sending unit 211, an instruction sending unit 212, and a lock-compare-write request sending unit 213.

Here, the data sending unit 211, which acts as a comparison data sending unit or replacement data sending unit, sends the permission patterns AP0 and AP1 and the next permission patterns NP0 and NP1 stored in the memory units 22a and 22b to the SSUs 30a and 30b through communication interfaces, not shown.

In particular, when an exclusive control instruction on the SSUs 30a, 30b is executed, the data sending unit 211 sends the permission pattern AP0 to the master SSU 30a among the SSUs 30. When the exclusive control instruction on the SSUs 30a, 30b is executed, the data sending unit 211 also sends the next permission pattern NP0 to the SSUs 30a and 30b before comparison between the permission pattern AP0 and readout pattern DA0 is performed by a comparing unit 312 which will be described later, in the master SSU 30a.

The lock-compare-write request sending unit 213 sends a lock-compare-write request to the SSUs 30a and 30b when an exclusive control instruction on the SSUs 30a and 30b is executed.

In the master SSU 30a, the lock-compare-write request causes the comparing unit 312 to compare the readout pattern DA0 stored in a register 315 with the permission pattern AP0 stored in a register 316. The lock-compare-write request includes an instruction that, if the comparison by the comparing unit 312 depicts that the readout pattern DA0 matches the permission pattern AP0, causes the SSU 30a to overwrite a predetermined area in the memory 32a with the next permission pattern NP0 stored in a register 317 to prepare for a duplication write and, when subsequently a duplication write request is sent from the cluster 20, causes the SSU 30a to replace the readout pattern DA0 with the next permission pattern NP0.

The lock-compare-write request causes the slave SSU 30b to overwrite a predetermined area in the memory 32b with the next permission pattern NP0 stored in the register 317 to prepare for a duplication write and, when subsequently a duplication write request is sent from the cluster 20, causes the SSU 30b to replace the readout pattern DA0 with the next permission pattern NP0.

The lock-compare-write request is output from the lock-compare-write request sending unit 213 to each of the SSUs 30a and 30b as a single operation code. When the SSUs 30a and 30b receive the operation code, a replacing unit 313 and other components in each of the SSUs 30a and 30b perform processing according to the lock-compare-write request.

When the result of comparison by the comparing unit 312 that indicates that the permission pattern AP0 matches the readout pattern DA0 is sent from a comparison result sending unit 314, which will be described later, of the SSU 30a, the instruction sending unit 212 which functions as a replace instruction sending unit sends a duplication write request to each of the SSUs 30a and 30b to cause a replacing unit 313, which will be detailed later, to replace the readout pattern DA0, DA1 with the next permission pattern NP0.

When the result of comparison by the comparing unit 312 that indicates that the permission pattern AP0 and the readout pattern DA0 does not match is sent from the comparison result sending unit 314, the instruction sending unit 212 sends a duplication write abort request to each of the SSUs 30a and 30b to direct the SSUs 30a, 30b to abort the duplication write of the readout pattern DA0, DA1 with the next permission pattern NP0.

Each of the SSUs 30a and 30b is a storage unit that readably and writably stores data, has a control mechanism that allows the clusters 20a and 20b to efficiently perform parallel processing, and enables various data transfer instructions and exclusive control instructions as well as inter-cluster communication instructions to be executed.

As illustrated in FIG. 1, the SSU 30a includes interface units 31a-1 and 31a-2 and a memory 32a; the SSU 30b includes interface units 31b-1 and 31b-2 and a memory 32b.

The SSUs 30a and 30b store data sent from the clusters 20a and 20b. In the memory system 100, the two clusters 20a and 20b share the two SSUs 30a and 30b. In the description of the present embodiment, the memory 32a and 32b provided in the SSUs 30a and 30b are sometimes referred to as shared resources shared by the clusters 20.

The memory 32a and 32b store data readably and writably and may be implemented by any of various types of storage devices such as HDDs or semiconductor storage devices.

Interface units 31a-1, 31a-2, 31b-1, and 31b-2 write and read data to and from the memories 32a and 32b and provide control of processing including processing related to exclusive control instructions, which will be described later. The interface units 31a-1, 31a-2, 31b-1, and 31b-2 receive data and requests sent from the clusters 20a and 20b and write and read the data to and from the memory 32a and 32b according to the requests.

The interface units 31a-1, 31a-2, 31b-1, and 31b-2 send a report indicating the result of processing operation on the memories 32a, 32b to the clusters 20a, 20b that have sent the instruction.

In the example illustrated in FIG. 1, data can be written and read in the memory 32a through any of the interface units 31a-1 and 31a-2. Likewise, data can be written and read in the memory 32b through any of the interface units 31b-1 and 31b-2.

In the memory system 100, identical data is written in the SSUs 30a and 30b. This duplicates data between the SSUs 30a and 30b.

In particular, the same data is stored in a predetermined duplicated-data area in the memory 32a of the SSU 30a and a predetermined duplicated-data area in the memory 32b of the SSU 30b so that, in the event of failure in one of the SSUs 30a and 30b, the clusters 20a and 20b can access the same data in the other of the SSUs 30a and 30b.

A readout pattern which is data to be read out and used in control of exclusive instruction accesses by the clusters 20a and 20b is stored in predetermined locations in the data areas. In the example illustrated in FIG. 1, readout pattern DA0 is rewritably stored in the memory 32a and readout pattern DA1 is rewritably stored in the memory 32b.

The readout patterns DA0 and DA1 stored are data identical to each other. Any of the permission patterns AP0, AP1 and the next permission patterns NP0, NP1 described above is stored as the readout pattern DA0 and DA1.

That is, the readout pattern DA0, DA1 has the same number of bits as the permission patterns AP0, AP1 and the next permission patterns NP0, NP1.

In the memory system 100, the memory 32a and 32b functions as readout data holding areas that writably hold the readout pattern DA0, DA1.

The interface unit 31a-1 includes a readout pattern acquiring unit 311 which is a readout data acquiring unit, a comparator circuit 312 which is a comparing unit, a replacing unit 313, a comparison result sending unit 314, and registers 315, 316, and 317.

The interface units 31a-1, 31a-2, 31b-1, and 31b-2 have configurations similar to each other. In the following description, the reference symbols that are the same as those given above denote the same or similar components, the description of which will be omitted. For simplicity, detailed configurations of the interface units 31b-1 and 31b-2 are omitted from FIG. 1.

The readout pattern acquiring unit 311 acquires the readout pattern DA0 held in the predetermined area in the memory 32a. The readout pattern acquiring unit 311 reads the readout pattern DA0 from the memory 32a and stores it in the register 315 according to a lock-compare-write request sent from the cluster 20a.

The register (a readout data storage area, a first register) 315 is a data storage area temporarily storing a readout pattern DA0 acquired by the readout pattern acquiring unit 311 from the memory 32a. The register 315 has an enough capacity to store the readout pattern DA0.

The register 316 (a comparison data storage area, a second register) 316 is a data storage area temporarily storing a permission pattern AP0 which is comparison data sent by the data sending unit 211 of the cluster 20a. The register 316 has an enough capacity to store the permission pattern AP0.

The comparing unit 312 compares a permission pattern AP0 sent from the cluster 20a with a readout pattern DA0. The comparing unit 312 determines whether the readout pattern DA0 stored by the readout pattern acquiring unit 311 in the register 315 matches the permission pattern AP0 stored in the register 316.

The comparing unit 312 may be implemented by a comparator, for example. The comparator is commonly used, detailed description of which will be omitted. Alternatively, the functions of the comparing unit 312 may be implemented by software, instead of a hardware comparator. Variations of the comparing unit 312 can be implemented without departing from the spirit of the present embodiment.

The comparison result sending unit 314 sends the result of comparison by the comparing unit 312 to the clusters 20a, 20b. The comparison result sending unit 314 provided in the interface unit 31a-1 sends the result of comparison to the cluster 20a and the comparison result sending unit 314 provided in the interface unit 31a-2 sends the result of comparison to the cluster 20b.

The register (a replacement data storage area, a third register) 317 is a data storage area temporarily storing a next permission pattern NP0, NP1 sent from the cluster 20a, 20b. The register 317 has an enough capacity to store the next permission pattern NP0, NP1.

The register 317 provided in the interface unit 31a-1 stores a next permission pattern NP0 sent from the cluster 20a. The register 317 provided in the interface unit 31a-2 stores a next permission pattern NP1 sent from the cluster 20b.

The replacing unit 313 replaces readout pattern DA0, DA1 held in the memories 32a, 32b with the next permission patterns NP0, NP1 stored in the register 317 if comparison by the comparing unit 312 depicts that the permission pattern AP0 matches the readout pattern DA0.

The SSU 30b has a configuration similar to that of the SSU 30a. The interface unit 31b-1 of the SSU 30b has a configuration similar to that of the interface unit 31a-1 of the SSU 30a and the interface unit 31b-2 of the SSU 30b has a configuration similar to that of the interface unit 31a-2 of the SSU 30a. Detailed description of these interface units will be omitted herein for the sake of simplicity.

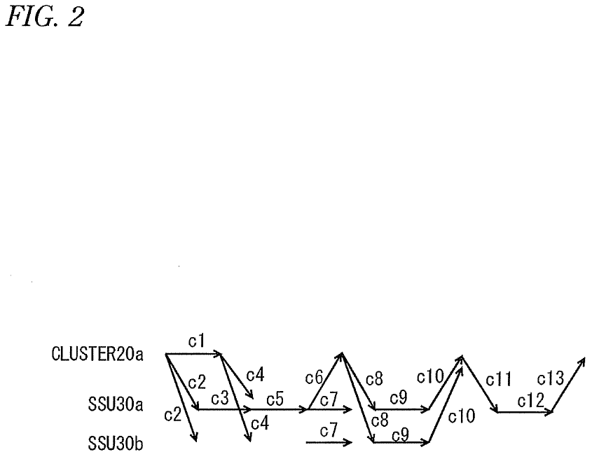

Referring to FIG. 2, a flow of a process will be described which is performed when a cluster 20 has gained access to a permission pattern in the memory system 100 of the present embodiment configured as described above. FIG. 2 illustrates a process flow when the cluster 20a has gained access.

First, the CPU 21a in the cluster 20a issues to the memory unit 22a a request to read a permission pattern AP0 and a next permission pattern NP0 and the memory unit 22a returns the permission pattern AP0 and the next permission pattern NP0 (see c1 in FIG. 2). The permission pattern AP0 and the next permission pattern NP0 read from the memory unit 22a are stored in send registers, not shown, in the cluster 20a.

The cluster 20a (CPU 21a) issues a lock-compare-write request for readout patterns DA0, DA1 to both of the master SSU 30a and to the slave SSU 30b (see c2 in FIG. 2).

In the SSU 30a, the readout pattern acquiring unit 311 reads out the comparison pattern DA0 from the memory 32a (see c3 in FIG. 2; the readout data acquiring step) and stores the read comparison pattern DA0 in the register 315 (the readout data storing step).

In the cluster 20a, the data sending unit 211 sends the permission pattern AP0 and the next permission pattern NP0 stored in the send registers to the SSUs 30a and 30b (see c4 in FIG. 2; the comparison data sending step, replacement data sending step).

In the SSU 30a, the permission pattern AP0 and the next permission pattern NP0 sent from the cluster 20a are stored in the registers 316 and 317, respectively (the comparison data storing step, replacement data storing step).

Then, in the SSU 30a, the comparing unit 312 compares the readout pattern DA0 stored in the register 315 with the permission pattern AP0 stored in the register 316 (see c5 in FIG. 2; the comparing step). The comparison result sending unit 314 sends the result of the comparison by the comparing unit 312 to the cluster 20a (see c6 in FIG. 2; the comparison result sending step). The result of the comparison in the example indicates that the readout pattern DA0 stored in the register 315 matches the permission pattern AP0 stored in the register 316.

In the SSU 30a, the replacing unit 313 starts preparation for dual write of the read pattern DA0 in the memory 32a with the next permission pattern NP0 stored in the register 317 (see c7 in FIG. 2).

The preparation for dual write involves acquiring information for the dual write such as address information of the location of the readout pattern DA0 in which the next permission pattern NP0 is to be written and computational operations.

When the comparison result indicating that the permission pattern AP0 matches the readout pattern DA0 is sent from the comparison result sending unit 314 to the cluster 20a, the instruction sending unit 212 in the cluster 20a sends a duplication write request to the SSUs 30a and 30b to instruct the SSUs 30a and 30b to replace the readout pattern DA0 with the next permission pattern NP0 (see c8 in FIG. 2; the replace instruction sending step).

Information for performing the duplication write has been sent to the SSU 30a at the steps labeled c2 (the operation code and the address of the readout pattern DA0) and c4 (the next permission pattern NP0).

In each of the SSUs 30a and 30b, the replacing unit 313 replaces the readout pattern DA0 in the memory 32a with the next permission pattern NP0 stored in the register 317 to accomplish duplication write (see c9 in FIG. 2; the replacing step).

Each of the SSUs 30a and 30b sends a duplication write completion report to the cluster 20a indicating that the duplication write has been performed (see c10 in FIG. 2).

When the duplication write completion reports for the read patterns DA0 and DA1 are returned from both of the SSUs 30a and 30b, the cluster 20a sends an unlock request to the SSU 30a (see c11 in FIG. 2).

The SSU 30a performs unlocking (see c12 in FIG. 2), and then sends a report to the cluster 20a indicating that the unlocking has been completed (see c13 in FIG. 2).

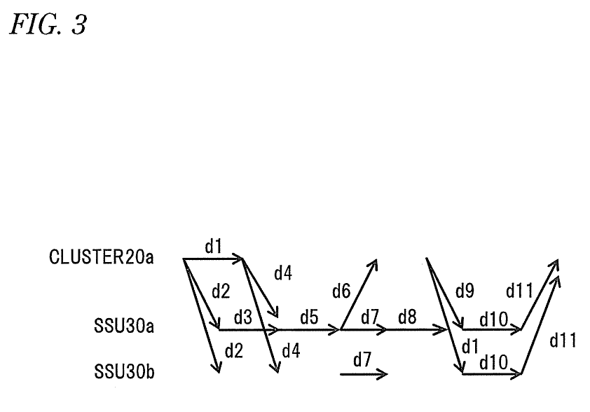

Referring to FIG. 3, a flow of process will be described next which is performed when a cluster 20 in the memory system 100 of the present embodiment has failed to gain access to a permission pattern. FIG. 3 illustrates an example in which the cluster 20a has failed to gain access.

First, the CPU 21a in the cluster 20a issues to the memory unit 22a a request to read a permission pattern AP0 and a next permission pattern NP0 and the memory unit 22a returns the permission pattern AP0 and the next permission pattern NP0 (see d1 in FIG. 3). The permission pattern AP0 and the next permission pattern NP0 read from the memory unit 22a are stored in send registers, not shown, in the cluster 20a.

The cluster 20a (CPU 21a) issues a lock-compare-write request for readout patterns DA0, DA1 to both of the master SSU 30a and the slave SSU 30b (see d2 in FIG. 3).

In the SSU 30a, the readout pattern acquiring unit 311 reads out the comparison pattern DA0 from the memory 32a (see d3 in FIG. 3; the readout data acquiring step) and stores the comparison pattern DA0 in the register 315 (the readout data storing step).

In the cluster 20a, the data sending unit 221 sends the permission pattern AP0 and the next permission pattern NP0 stored in the send registers to the SSUs 30a and 30b (see d4 in FIG. 3; the comparison data sending step, the replacement data sending step).

In the SSU 30a, the permission pattern AP0 and the next permission pattern NP0 sent from the cluster 20a are stored in the registers 316 and 317, respectively (the comparison data storing step, the replacement data storing step).

Then, the comparing unit 312 in the SSU 30a compares the readout pattern DA0 stored in the register 315 with the permission pattern AP0 stored in the register 316 (see d5 in FIG. 3; the comparing step). The comparison result sending unit 314 sends the result of the comparison by the comparing unit 312 (indicating that the readout pattern DA0 stored in the register 315 does not mach the permission pattern AP0 stored in the register 316) to the cluster 20a (see d6 in FIG. 3; the comparison result sending step).

In the SSU 30a, the replacing unit 313 starts preparation for duplication write of the readout pattern DA0 in the memory 32a with the next permission pattern NP0 stored in the register 317 (see d7 in FIG. 3).

When the comparison by the comparing unit 312 depicts that the readout pattern DA0 stored in the register 315 does not match the permission pattern AP0 stored in the register 316, the SSU 30a autonomously unlocks the memory 32a (see d8 in FIG. 3).

When the result of comparison by the comparing unit 312 indicating that the readout pattern DA0 stored in the register 315 does not match the permission pattern AP0 stored in the register 316 is returned from the comparison result sending unit 314, the instruction sending unit 212 in the cluster 20a performs the following operation. The replacing unit 313 sends a duplication write abort request to the SSUs 30a and 30b to direct the SSUs 30a and 30b to abort the duplication write of the readout patterns DA0, DA1 with the next permission pattern NP0 (see d9 in FIG. 3).

In each of the SSUs 30a and 30b, the replacing unit 313 aborts the duplication write of the readout pattern DA0, DA1 with the next permission pattern NP0 (see d10 in FIG. 3). A duplication write abort completion report is sent to the cluster 20a indicating that the duplication write has been aborted (see d11 in FIG. 3).

In this way, in the memory system 100 of the present embodiment, the SSU 30a includes the registers 315 and 316 and the comparing unit 312, which compares the permission pattern AP0 with the readout pattern DA. Then the comparison result sending unit 314 sends the result of the comparison to the cluster 20a. Concurrently with the sending of the comparison result by the comparison result sending unit 314, the replacing unit 313 starts to make preparation for duplication write of the readout pattern DA0 in the memory 32a with the next permission pattern NP0 stored in the register 317. Therefore, the duplication write of the readout pattern DA0 can be more quickly started. This can reduce the time required for gaining access and improve the performance of the system.

Prior to comparison between the permission pattern AP0 and the readout pattern DA0 in the SSU 30a, the permission pattern AP0 and the next permission pattern NP0 are read from the memory unit 22a in the cluster 20a and are sent to the SSUs 30a and 30b. Therefore, the time between the comparison between the readout pattern DA0 and the permission pattern AP0 by the comparing unit 312 and the completion of the duplication write of the readout patterns DA0, DA1 can be reduced. This can further reduce the time required for gaining access and improve the performance of the system.

Furthermore, because the next permission pattern NP0 is read out from the memory unit 22a, 22b at the same time the permission pattern AP0 is read out (see c1 in FIG. 2), processing time required for the exclusive control instruction can be reduced.

Today's storage devices are capable of serving multiple requests simultaneously. If a storage device has multiple banks, data can be read from the banks simultaneously. Accordingly, the time required for reading out the permission pattern AP0 and the next permission pattern NP0 simultaneously is less than twice the time required for reading out only the permission pattern AP0. Therefore, it is apparent that the time required for reading the permission pattern AP0 and the next permission pattern NP0 from the memory units 22a and 22b can be reduced.

The provision of the registers 315 and 316 as well as the comparing unit 312 in the SSU 30a enables comparison between the permission pattern AP0 and the readout pattern DA0 by the comparing unit 312 even if the cluster 20a fails to gain access to the SSUs 30a, 30b. Therefore, when the comparison depicts that the readout pattern DA0 stored in the register 315 does not match the permission pattern AP0 stored in the register 316, the memory 32a can be autonomously unlocked. This can reduce the time between the locked-read of the readout pattern DA0 and the unlocking.

Since the time between the locked-read of the readout pattern DA0 and unlocking can be reduced as described above, the system performance can improve as the number of clusters 20 increases.

The functions of the data sending unit 211, the instruction sending unit 212, and the lock-compare-write request sending unit 213 can be implemented by any combination of hardware components. A program stored in internal storage devices (memory units 22a, 22b in the present embodiment and other RAM and ROM, not shown) may be executed by microprocessors of computers (CPUs 21a, 21b in the present embodiment). The program stored in a recording medium may be read and executed by the computers.

The computer in the present embodiment is a concept including hardware and an operating system and represents hardware operating under the control of the operating system. In a system where an application program by itself causes hardware to operate without needing an operating system, the hardware itself represents the computer. The hardware includes at least a microprocessor such as a CPU and reading means for reading a computer program recorded on a recording medium. In the present embodiment, clusters 20 have the functions of the computer.

The recording medium in the present embodiment may be a flexible disk, CD, DVD, blue-ray disc, magnetic disk, optical disc, magneto-optical disc, an IC card, ROM cartridge, magnetic tape, punched card, computer internal storage device (memory such as RAM or ROM), external storage, or any of various computer-readable media such as a printed material on which a code such as a barcode is printed.

The disclosed memory system and control method are not limited to the embodiment described above. Variations of the embodiment are possible without departing from the present embodiment.

Given that the embodiment has been disclosed, those skilled in the art can carry out and manufacture the present embodiment.

What is claimed is:

1. A control method for a memory system including a plurality of processing apparatuses each having a comparison data holding area and a replacement data holding area, and a plurality of storage units each having a readout data holding area rewritably holding readout data and a memory unit shared by the plurality of processing apparatuses, the control method comprising:
issuing an exclusive control instruction to exclusively access to one of the memory units from one of the processing apparatuses;
sending comparison data to one of the plurality of storage units from the comparison data holding area of the one of the processing apparatuses when the exclusive control instruction is executed; and
comparing the comparison data sent from the one of the processing apparatuses with the readout data in the storage unit.

2. The control method according to claim 1, further comprising sending replacement data to each of the plurality of storage units before comparing the comparison data with the readout data by the comparing unit in the storage unit by the processing apparatuses.

3. The control method according to claim 2, further comprising:
storing the replacement data sent in the replacement data sending in a replacement data storage area by the storage unit; and
replacing the readout data stored in the readout data holding area with the replacement data stored in the replacement data storage area,
wherein, if the comparison in the comparing indicates that the comparison data matches the readout data, the storage unit starts preparation processing for the replacement of the readout data in the replacing.

4. The control method according to claim 3, further comprising:
sending the result of the comparison in the comparing step to the processing apparatus by the storage unit, wherein
if the comparison result indicating that the comparison data matches the readout data is sent in the comparison result sending, sending, by an instruction to each of the plurality of storage units to instruct the storage unit to replace the readout data with the replacement data in the replacing by the processing apparatus.

5. The control method according to claim 1, further comprising:
storing the comparison data sent in the comparison data sending in a comparison data storage area by the storage unit;
acquiring the readout data held in the readout data holding area by the storage unit; and
storing the readout data acquired in the readout data acquiring in a readout data storage area by the storage unit,
wherein the comparison data stored in the comparison data storage area is compared with the readout data stored in the readout data storage area.

6. A memory system including a plurality of processing apparatuses each having a processor, and a plurality of storage units each having a memory unit communicably connected to each of the plurality of processing apparatuses and being shared by the plurality of processing apparatuses, each of the plurality of processing apparatuses being capable of executing an exclusive control instruction to exclusively access the memory unit, each of the processing apparatuses comprising:
a comparison data holding area holding comparison data;
a replacement data holding area holding replacement data; and
a comparison data sending unit sending the comparison data to one of the plurality of storage units when the exclusive control instruction to the memory unit is executed; and
the storage unit comprises:
a readout data holding area rewritably holding readout data; and
a comparing unit comparing the comparison data sent from the processing apparatus with the readout data.

7. The memory system according to claim 6, wherein each of the processing apparatuses comprises a replacement data sending unit sending the replacement data to each of the plurality of storage units before the comparing unit compares the comparison data with the readout data in the storage device when the processing apparatus executes the exclusive control instruction to the memory unit.

8. The memory system according to claim 7, wherein the storage unit comprises a replacement data storage area storing the replacement data sent by the replacement data sending unit and a replacing unit replacing the readout data held in the readout data holding area with the replacement data stored in the replacement data storage area, and
if the comparison by the comparing unit indicates that the comparison data matches the readout data, the storage unit starts preparation processing for the replacement of the readout data by the replacing unit.

9. The memory system according to claim 8, wherein
the storage unit comprises a comparison result sending unit sending the result of the comparison by the comparing unit to the processing apparatus; and
each of the processing apparatuses comprises a replace instruction sending unit sending an instruction to each of the plurality of storage units to cause the replacing unit to replace the readout data with the replacement data when a comparison result indicating that the comparison data matches the readout data is sent from the comparison result sending unit.

10. The memory system according to claim 6, wherein
the storage unit comprises:
a comparison data storage area storing the comparison data sent by the comparison data sending unit;
a readout data acquiring unit acquiring readout data held in the readout data holding area; and
a readout data storage area storing the readout data acquired by the readout data acquiring unit;
wherein the comparing unit compares the comparison data stored in the comparison data storage area with the readout data stored in the readout data storage area.
